(19) United States
(12) Patent Application Publication
(10) Pub. No.: US 2015/0302600 A1
(43) Pub. Date: Oct. 22, 2015

(54) METHOD FOR OBFUSCATING IMAGES OR VIDEO TO PREVENT DIGITAL RECORDING OR CAPTURE WHILE REMAINING VISIBLE TO HUMANS

(71) Applicant: Karl Joseph Kreder, III, Austin, TX (US)

(72) Inventor: Karl Joseph Kreder, III, Austin, TX (US)

(21) Appl. No.: 14/692,692

(22) Filed: Apr. 21, 2015

Related U.S. Application Data
(60) Provisional application No. 61/982,086, filed on Apr. 21, 2014.

(51) Int. Cl. G06T 7/00; G06K 9/34

(52) U.S. Cl. CPC G06T 7/0081; G06K 9/34

(57) ABSTRACT

Systems and methods for obfuscating an image include creation of a plurality of obfuscated images from an original image, and successive display of the obfuscated images on a display device. Successive display of the images creates a representation of the original image perceivable by a user. Creation of the obfuscated images can include application of a set of masks to the original image, or to multiple starting images created by separating the original image based on characteristics, such as color. Portions of the original image or starting images corresponding to selected regions of the mask can be displayed, while portions corresponding to other regions can be concealed. Use of complementary masks results in the generation of complementary obfuscated images that, when combined, would form the original image. As a result, attempts to use a screen capture would only acquire the single obfuscated image displayed at the moment of the capture.

### CROSS-REFERENCED TO RELATED APPLICATIONS

This application claims the benefit of U.S. Provisional Application No. 61/982,086 filed Apr. 21, 2014.

### FIELD

Embodiments usable within the scope of the present disclosure relate, generally, to systems and methods for presenting images to a user, and more specifically, to systems and methods for presenting a series of images to a user in a manner such that any individual image is not perceived by the user to be meaningful and/or clear, but when displayed in association with one another (e.g., in rapid succession), the user can perceive an image corresponding to the original image from which the series of images was derived.

### BACKGROUND

There currently exist application(s) that allow the user of an electronic device, such as a personal computer, tablet, or smartphone, to send images and/or video to other users of the application, such that the receiver is only able to view the picture for a limited period of time. Present examples of such applications, that are used primarily on smartphones, include SnapChat, Wickr, and Facebook Poke. One of the perceived advantages of using such a system is the ability for users to send pictures or video to each other that will, presumably, not remain persistently available after the expiration o the limited period of time. One of the major shortcomings of such systems is that the receiver of an imagine can use a “screen capture” functionality built into the operating system of his or her electronic device to make a copy of the picture that was sent, during the time period in which the imagine is available for viewing. As such, the recipient is able to make a copy of the image before the original image that was sent is permanently deleted at the expiration of the time period. In this manner, the receiver can obtain a persistent copy of the image that was intended by the sender to only be temporarily available. This is a fundamental flaw in the currently available systems for sending images that have a finite lifetime. A need exists for systems and methods for obfuscating images and/or video in a manner that can prevent digital capture and the creation of permanent copies of the image and/or video, while the content still remains perceivable to the human eye.

### SUMMARY

Embodiments usable within the scope of the present disclosure include systems and methods usable to separate an image into a set of partial images, to present a single partial image to a user at any instant in time, and to present the set of images in series/sequence (e.g., rapidly in succession) such that the full image will be perceptible to the user's vision. The refresh rate of the display of most electronic devices is typically at least 60 hertz or greater. Because the human eye is not able to capture images at a rate of 60 hertz, a “blurring” of the partial images will occur, and will be perceived by the user's eye as the full image or a representation extremely similar thereto. If the screen capture feature of a receiving device is used, however, only the single partial image currently displayed will be captured. Each partial image can contain an amount of data insufficient for the full image to be perceived when viewed.

To account for the possibility that a receiver could attempt to capture multiple screen shots and/or use a screen recording feature of the receiving device, during the period over which an image is displayed, then attempt to reconstruct the original image from the multiple partial images that are obtained, in an embodiment, multiple sets of obfuscated images can be generated, and the sequence of partial imagines presented can be changed, such that even if multiple screen captures are made, different parts of the image would be displayed such the receiver would not be able to reconstruct the full image.

While embodiments described herein refer to “images,” generally, it should be understood that embodied systems and methods could similarly be applied to a video and/or .gif file. For example, each frame of a video can be treated as a static image, and a set of obfuscated images can be created for each frame. The obfuscated images for each frame can be rapidly displayed for a period of time, which corresponds to the frame rate of the obfuscated video, before displaying the set of obfuscated image for the next frame in sequence, such that the video remains perceptible to the human eye, but any attempts to utilize a screen capture function would yield only a partial imagine with insufficient data to visualize the full image.

In an embodiment, the formation of partial images (from a full image) can utilize display technologies that enable the portrayal of colors which are considerably larger than the actual colors that are used to create those colors. The most widespread example of this color representation, or color model, would be the red, green, blue, or RGB color model. The RGB color model is able to represent a large variety of colors by displaying a red component, a green component, and a blue component simultaneously. By varying the intensity of each of the color components, different colors can be created which are perceived by the user. Current display technologies attempt to create a color representation that is appealing to the user by minimizing the user's ability to perceive the RGB components individually. This is typically accomplished by making the pixel size as small as possible, as uniform as possible, and to update the display as frequently as possible.

Rather than minimizing the impact of the use of the color model, embodiments usable within the scope of the present disclosure can create a set of images that are highly influenced by the color model, such that when any single image is viewed by a recipient, the original image from which the set is derived is obfuscated. For example, pseudo-random and/or regular regions of an image, generally larger than a pixel, can be selected, and each region can display one or more of the components of the color model in any given area. This pattern may hereafter be referred to as a “mask.” In an embodiment, a mask can be sized to correspond to the size of an image to be obfuscated, and in further embodiments, feature sizes of the mask can be adjusted to correspond to feature sizes of the original image. For example, if the RGB color model is used, this process can create an image that appears to include patches of red, green, and blue, and that largely obfuscates the original image. Other complementary images within the set can include patches of red, green, and blue, positioned at locations necessary to complete the image. To make the original image visible to the user, the set of images can be displayed in rapid succession, such that the images appear (to the human eye) to blur together, such that the user perceives the original image from which the set was created. As such, the set of images that are created from the original image can be created in such a way that the averaging of the images (e.g., the successive, rapid display thereof) creates a perceived image which closely resembles the original image. A set of images that is able to accomplish this may hereafter be referred to as a “complementary set.”

While the RGB color model is widely used, it should be understood that any color model or similar method of dividing an image into a set of complementary images could be used without departing from the scope of the present disclosure. Some color models that could be used include, without limitation, red, green, and blue (RGB), red, green, blue, and yellow (RGBY), LAB, XYZ, UVW, sRGB, Adobe RGB, Adobe Wide Gamut RGB, YIQ, YUV, YDdDr, YPbPr, YCbCr, xvYCC, & CMYK color models. In addition to well defined color models, new color models could be created for the purpose of obfuscating the image; however, embodiments of the present methods and systems can be applicable with any desired color model or similar method of dividing an image into a set of complementary images.

In addition to or in lieu of displaying components of a color model separately to achieve an obfuscated image, other methods of masking the original image can be used. For example, in an embodiment, the hue, saturation, and/or lightness of a picture could be adjusted. A mask (that may be different from the mask used to alter the color components) is chosen, and each area of the mask can be assigned an adjustment factor for the given property that is being modified. For example, the original image could be represented with a hue, saturation, value (HSV) model, which is a three dimensional representation of the RGB color model. If the saturation value is to be adjusted to aid in the obfuscation of the image, adjustment factors could be assigned to each area of the mask so that each area will have the saturation value modified. The complementary image(s) would then be generated having saturation values modified in roughly the opposite manner so that when the images are in sequence, there is little or no effect on the apparent saturation value. In addition to the saturation, other properties of the picture could be modified such as lightness, hue, and value.

The creation of multiple images (e.g., a set of complementary images) from a single original image can thereby prevent all data from an original image from being presented to a recipient at one time. This prevents or inhibits the recipient from capturing and/or permanently storing an image intended to be only temporarily available. In an embodiment, attempts by a user to capture a displayed image can be detected, responsive to which the program used to display the images (e.g., in succession) can cease the continued display of the set of images. Doing so prevents the recipient from permanently capturing and/or storing sufficient data to reconstruct the original image.

### BRIEF DESCRIPTION OF THE DRAWINGS

In the detailed description of various embodiments usable within the scope of the present disclosure, presented below, reference is made to the accompanying drawings, in which:

FIG. 1 depicts a flowchart illustrating an embodiment of a method for obfuscating images usable within the scope of the present disclosure.

FIG. 2 depicts a flowchart showing an embodiment of a method of obfuscating an image to prevent digital capture, while making the image visible to a user.

FIG. 3 depicts a flowchart that shows an embodiment of a process for creating a set of obfuscated images from a starting image.

FIG. 4 depicts a flowchart which shows an embodiment of a process for applying multiple obfuscating masks to an image.

FIG. 5 depicts a flowchart showing an embodiment of a process for adjusting the mask(s) used to obfuscate an image based upon an analysis of the image.

FIG. 6 depicts a flowchart showing an embodiment of a process for creating and using multiple different sets of obfuscated images to represent a single image.

FIG. 7 depicts a flowchart showing an embodiment of a method for using sets of continuous masks to obfuscate an image.

FIG. 8 depicts a flowchart showing a method for applying obfuscating processes to a video, to create an obfuscated video.

FIG. 9 depicts a color image of an exemplary starting image, a rooster, which is shown in subsequent figures, obfuscated using various techniques.

FIG. 10 depicts an enlarged inset of the image of the rooster showing greater detail of the image.

FIG. 11 depicts a color image illustrating the blue color component of the image shown in FIG. 9.

FIG. 12 depicts a color image illustrating an enlarged region of the image shown in FIG. 11.

FIG. 13 depicts a color image illustrating the red color component of the image shown in FIG. 9.

FIG. 14 depicts a color image illustrating an enlarged region of the image shown in FIG. 13.

FIG. 15 depicts a color image illustrating the green color component of the image shown in FIG. 9.

FIG. 16 depicts a color image illustrating an enlarged region of the image shown in FIG. 15.

FIG. 17 depicts an exemplary embodiment of a first continuous mask that can be applied to a color channel to obfuscate an image.

FIG. 18 depicts an enlarged region of the image shown in FIG. 17.

FIG. 19 depicts an exemplary embodiment of a second continuous mask that can applied to a color channel to obfuscate an image.

FIG. 20 depicts an enlarged region of the image shown in FIG. 19.

FIG. 21 depicts a color image illustrating the application of the continuous mask shown in FIG. 19 to the red color component of the image shown in FIG. 13.

FIG. 22 depicts a color image illustrating an enlarged region of the image shown in FIG. 21.

FIG. 23 depicts a grayscale representation of the image shown in FIG. 21.

FIG. 24 depicts an enlarged region of the image shown in FIG. 23.

FIG. 25 depicts a color image illustrating the image that results when three different masks, similar to that shown in FIG. 17, are applied to the red, green, and blue color components of the image of FIG. 9, shown in FIGS. 13, 15, and 11, respectively.

FIG. 26 depicts a color image showing an enlarged region of the image shown in FIG. 25.

FIG. 27 depicts a color image illustrating a complementary image to that shown in FIG. 25.

FIG. 28 depicts a color image showing an enlarged region of the image shown in FIG. 27.

FIG. 29 depicts an exemplary discrete mask having six different color channels.

FIG. 30 depicts an enlarged region of the image shown in FIG. 29.

FIG. 31 depicts a legend indicating the areas of FIG. 29 that correspond to different color components and/or color channels.

FIG. 32 depicts a color image illustrating an exemplary result obtained by applying a discrete mask similar to that shown in FIG. 29 to the image of FIG. 9.

FIG. 33 depicts a color image showing an enlarged region of FIG. 32.

FIG. 34 depicts a color image illustrating a complementary image to that shown in FIG. 32.

FIG. 35 depicts a color image showing an enlarged region of FIG. 34.

FIG. 36 depicts a color image showing a representation perceived by the human eye when a complementary set of images are displayed in rapid succession.

FIG. 37 depicts a color image showing an enlarged region of FIG. 36.

FIG. 38 depicts a color image showing an exemplary result obtained by applying a three-component discrete mask to the image of FIG. 9.

FIG. 39 depicts a color image showing an enlarged region of FIG. 38.

FIG. 40 depicts a color image illustrating a complementary image to that shown in FIG. 38.

FIG. 41 depicts a color image showing an enlarged region of FIG. 40.

FIG. 42 depicts a color image illustrating a complementary image to those shown in FIGS. 38 and 40.

FIG. 43 depicts an color image showing an enlarged region of FIG. 42.

One or more embodiments are described below with reference to the listed Figures.

### DETAILED DESCRIPTION OF THE EMBODIMENTS

Before describing selected embodiments of the present invention in detail, it is to be understood that the present invention is not limited to the particular embodiments described herein. The disclosure and description herein is illustrative and explanatory of one or more presently preferred embodiments of the invention and variations thereof, and it will be appreciated by those skilled in the art that various changes in the design, organization, order of operation, means of operation, equipment structures and location, methodology, and use of mechanical equivalents may be made without departing from the spirit of the invention.

As well, it should be understood the drawings are intended illustrate and plainly disclose presently preferred embodiments of the invention to one of skill in the art, but are not intended to be manufacturing level drawings or renditions of final products and may include simplified conceptual views as desired for easier and quicker understanding or explanation of the invention. As well, the relative size and arrangement of the components may differ from that shown and still operate within the spirit of the invention as described throughout the present application.

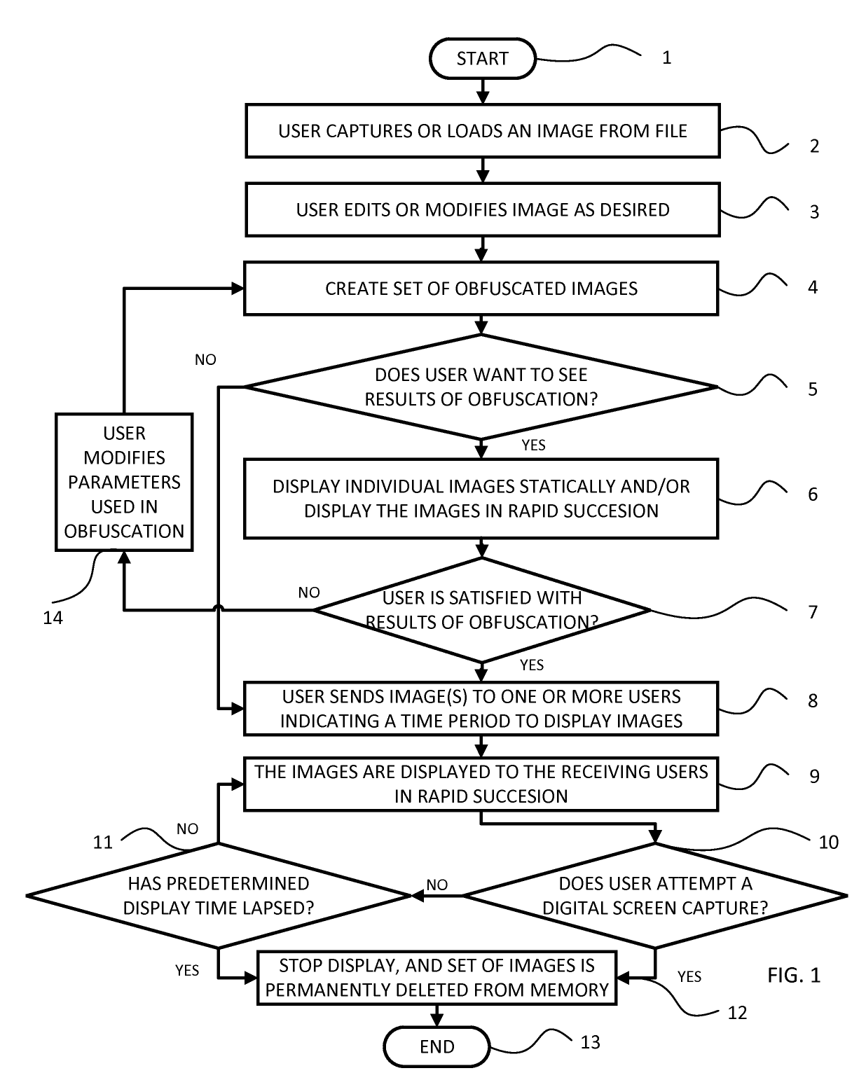

FIG. 1 depicts a flowchart illustrating an embodiment of a method for obfuscating images usable within the scope of the present disclosure. In use, users can be enabled to send images to one another that are perceptible to the human eye, while ensuring that the receiving user is unable to capture and retain a persistent copy of the original image. As such, users can send images to one another that are only in existence and/or accessible for a predetermined, temporary period of time, after which the images can be permanently deleted, thus allowing users to control the permanence and further distribution/dissemination of any transmitted content. While embodiments herein are described for use with images and/or video, it should be understood that any type of content could be transmitted for temporary access and subsequent deletion, and that embodiments described herein could be used with any manner of content without departing from the scope of the present disclosure.

At the start (1) of the depicted method, a first user (sender) captures or load an image (e.g., from a file) (2) to be sent to one or more other users. In an embodiment, the first user can edit or modify the image (3) if desired. For example, modifications could include the application of filters to the image (e.g., brightening, increasing contrast, and/or adding aesthetic frames and features). Modifications could also include adding text, drawings, and/or annotations to the image. Once any edits/additions, if made, are completed, this uploaded image (edited, if applicable) is hereafter termed the “original image.” A set of obfuscated images is created from the original image (4), as described in more detail above and below. In an embodiment, the user/sender can be provided with an option to preview the results of the obfuscation (5) before sending the image to other users. If the user exercises the option to preview the results of obfuscation, each image of the obfuscated set, or a subset of the obfuscated set, can be individually displayed to the user (e.g., statically), and/or the images could be presented to the user in rapid succession (6). Viewing of static images enables the sending user to preview possible individual images that a receiver would be able to capture if a screen capture feature on the receiving device is used, while viewing the images in succession enables the sending user to preview the content the receiving user would be able to visualize when the images are presented on the receiving device for viewing. The sending user can then be provided with the option to approve or disapprove the obfuscation (7). If the user disapproves of the obfuscation, the user can modify parameters to change how the obfuscation process is performed (14). For example, the user can be permitted to select the number of images in the obfuscated set, the number of masks used in the obfuscation, the parameters which are modified by the masks, the average feature size of the masks, and/or other similar features. A set of obfuscated images could then be created through the obfuscation process (4) using the inputs/parameters supplied by the user. Once the user affirms the results of obfuscation, the sending user can select one or more recipients for the image and a period of time for which the image will be displayed to receiving users (8). The set of obfuscated images is then displayed to the receiving users in rapid succession (9), thus enabling the users to visualize the image in spite of the obfuscation thereof. The display of the image can occur until the predetermined time period lapses (11), or until an attempt to capture an image, by the receiving device, is detected (10). If an attempt to capture the image is detected, or the period of time set by the sender elapses, the displaying of the sequence of obfuscated images is stopped, and the images are permanently deleted from memory (12), thus terminating the process (13).

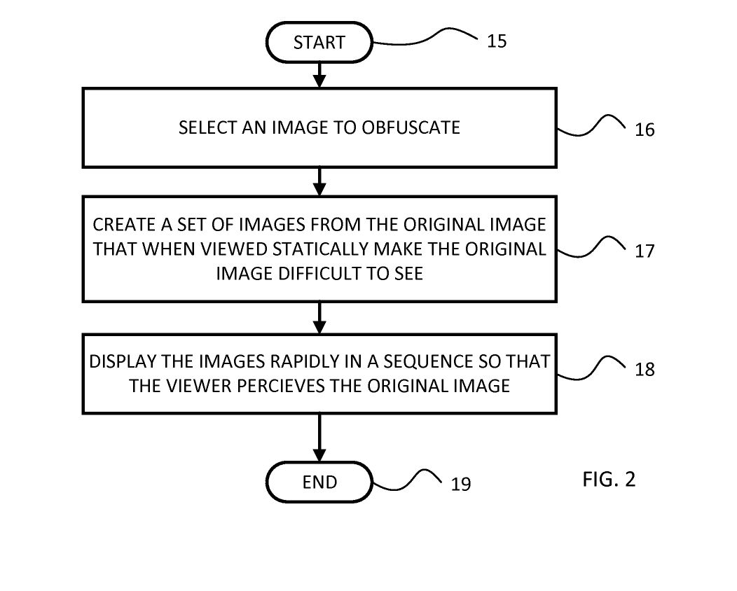

FIG. 2 depicts a flowchart showing an embodiment of a method of obfuscating an image to prevent digital capture, while making the image visible to a user. At the start of the method (15), an image is selected to be obfuscated (16). A set of images is then created from the original image, such that when any individual image of the set is viewed statically, it difficult to visually discern what is shown in the original image (17.) The original image can be viewed by displaying the images in the obfuscated set of images in rapid succession (18), thus ending the obfuscation process (19).

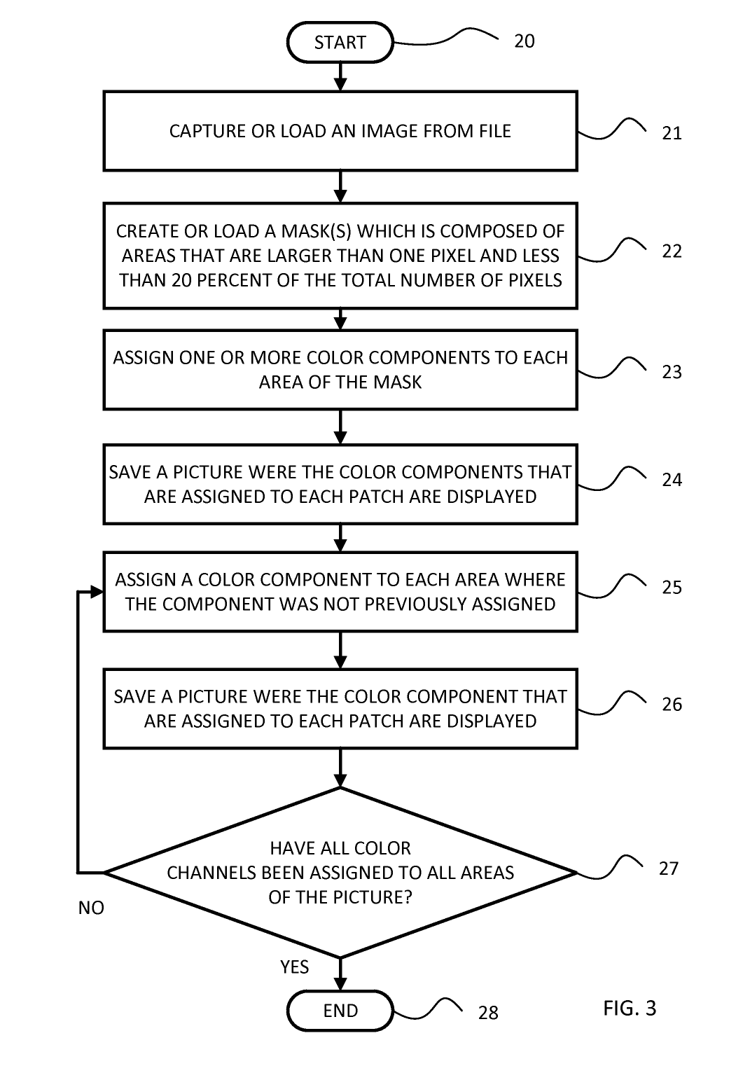

FIG. 3 depicts a flowchart showing an embodiment of a method for creating a set of obfuscated images from a starting image. At the start of the method (20), a user can select an image to be obfuscated (e.g., by capturing and/or loading an image from a file) (21). A set of masks is then created and/or loaded (22), each mask having areas that are larger than one pixel and less than twenty percent of the total number of pixels in the image, the masks being usable to obfuscate the image. The created set of masks can include a complementary set—e.g., after application thereof to the image, the resulting set of images, when displayed rapidly in sequence, can visually generate an image similar to the original image. For example, one or more color components can be assigned to each area in each mask (23). An image is then created (e.g., saved) by using the color components from the original image picture that are indicated by corresponding areas of the mask, thereby creating a new obfuscated image (24). New color components can then be assigned to other areas of the mask where they were not previously assigned (25). A new image can then e saved in a similar manner, using color components of the original image corresponding to areas of the mask (26). The process of re-assigning color components and saving a new obfuscated image can continue until all areas of the mask have been assigned all of the color channels used in the chosen color model (27), thus completing the process (28). Once all the images are created from the mask(s), the resulting set of images can be a set of complementary images. The original image can then be visualized (e.g., by the human eye) by displaying the set of complementary images in rapid succession.

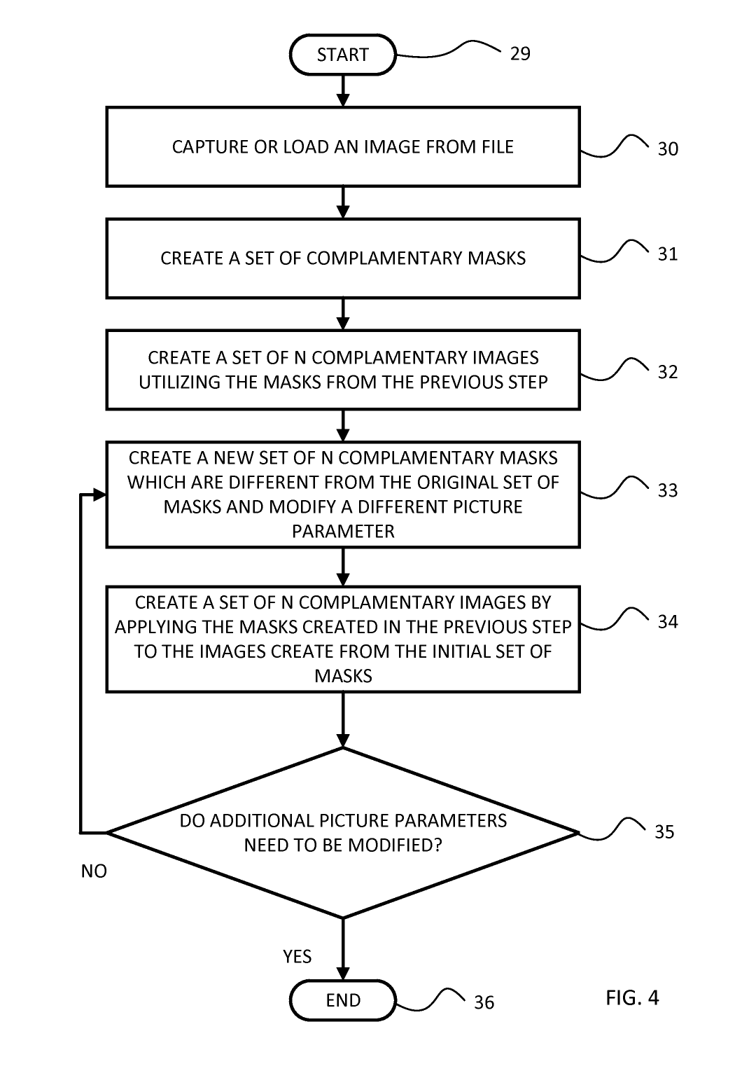

FIG. 4 depicts a flowchart showing an embodiment of a process for applying multiple obfuscating masks to an image. In some cases it may be desirable to apply multiple sets of masks to an image to better obfuscate the image. Each set of masks used could be applied to a different parameter of the photo. For example one set of masks can modify color (e.g., by creating complementary images, each containing different color channels for different regions of the original image), while another set of masks could modify saturation. The process of applying multiple masks can enhance the difficulty in reconstructing the original image from a single obfuscated image. At the start of the process for obfuscating an image using more than one set of masks (29), the first step is to capture or load an image from a file (30). One or more sets of complementary masks can then be created (31), each mask modifying a certain property of the original image, such as the color component. A set of n complementary images, n being an integer, is then created using the set of complementary masks (32). A new set of n complementary masks can then be created, each mask modifying a property different from the property modified by the first set of masks (33). A new set of n obfuscated images, complementary to one another, can then be created by applying the newly created set of masks masks to the previously created obfuscated images (34). If additional picture parameters should be modified (35), the steps of creating a new set of n complementary masks for use modifying a different parameter (33) and creating a new set of n obfuscated images by applying the masks (34) can be repeated as many times as desired to enhance the obfuscation. When it is no longer desirable to modify new parameters, the process can be terminated (36).

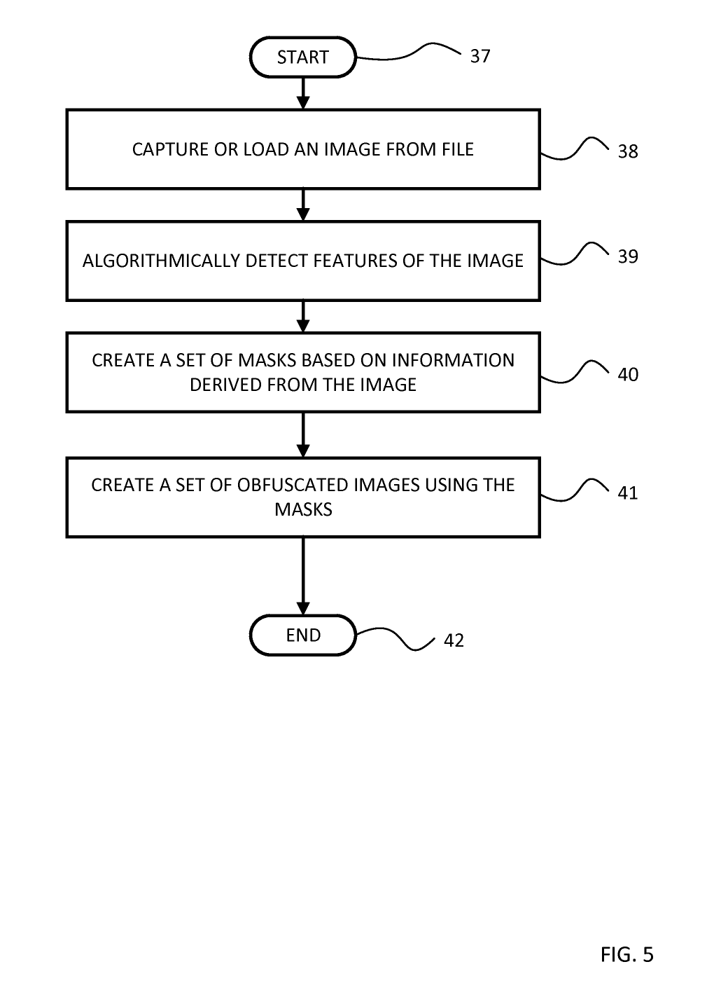

FIG. 5 depicts a flowchart showing an embodiment of a process for adjusting the mask(s) used to obfuscate an image based upon an analysis of the image. For example, when obfuscating an image, certain masks and/or types of masks may be more suitable for obfuscating a certain image when compared to other makes and/or types of masks. By performing an analysis of the image to be obfuscated before creating the masks and subsequently, the obfuscated images, the results of the obfuscation process may be better optimized. At the start of the process (37) for creating and/or selecting one or more optimal masks, an image is captured or loaded (e.g., from a file) (38). The image can be algorithmically analyzed, e.g., to detect features thereof that can be obfuscated (39). The outputs of this analysis could include, without limitation, the size of the image, the resolution of the image, the average feature size of the image, and one or more characteristics of the features of the image. These features could also be reported for certain areas of the image and/or for the overall image. Based on the information derived from the image and/or portions thereof, a set of masks can be created (40), the masks having parameters and/or characteristics selected to optimally obfuscate the image and/or portions thereof. At the end of the process (42), a set of obfuscated images can then be created by applying the masks created using the analysis to the original image (41), the obfuscated images being complementary to one another.

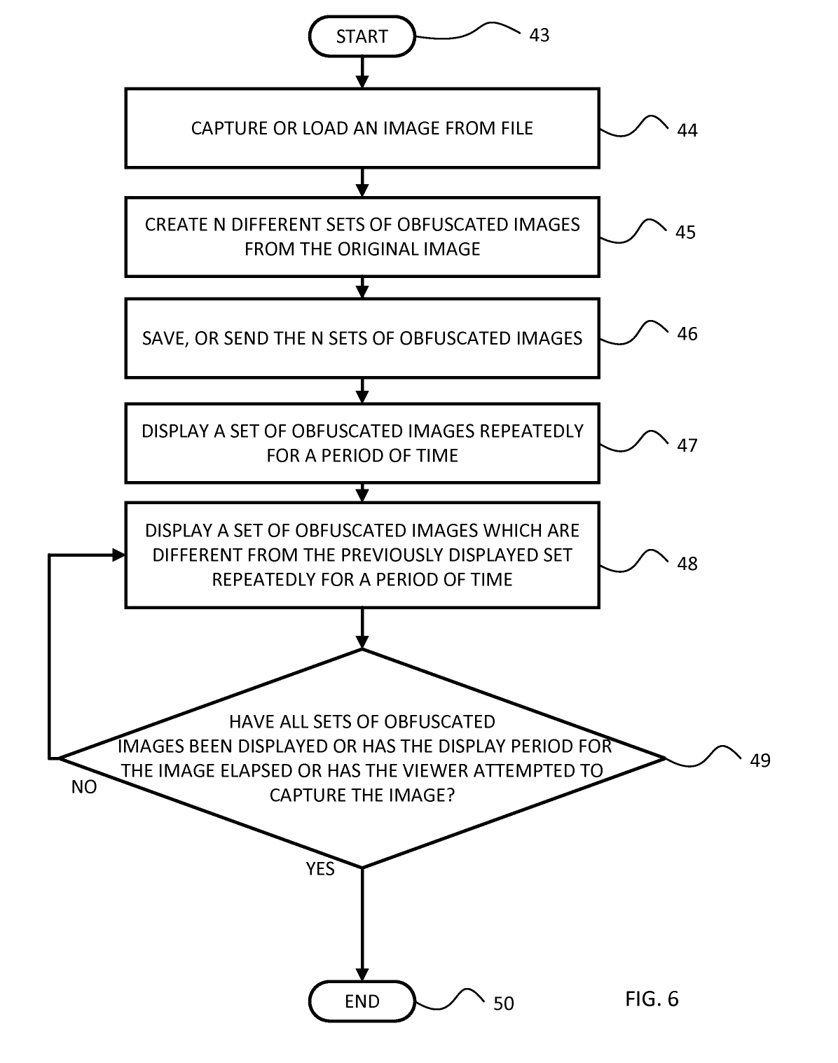

FIG. 6 depicts a flowchart showing an embodiment of a process for creating and using multiple different sets of obfuscated images to represent a single image (e.g., an original image). The creation of multiple sets of obfuscated images can hinder or prevent a receiving user from capturing multiple screen shots while a single set of obfuscated images is being displayed, then attempting to reconstruct the original image from the captured images. Use of multiple, different sets of obfuscated images can cause the capture of sufficient static images to reconstruct the original image to become more difficult. For example, a recipient attempting to utilize screen capture features of a receiving device would capture static images from different sets of obfuscated images, decreasing the likelihood that sufficient data would be captured to reconstruct the original image, and increasing the difficulty of such a reconstruction. At the start of the method (43), a user intending to obfuscate an image can capture or load an image from a file (44). Then, instead of creating a single set of obfuscated images from the original image, as described above, multiple sets of obfuscated images (e.g., N sets, wherein N is an integer) can be created (45). For example, several different sets of masks could be used to create sets of obfuscated images that are unique from one another. The N different sets of obfuscated images can then be saved for later use, and/or sent to one or more recipients (46). To enable visualization of the original image by a recipient, one of the obfuscated sets of images can be presented to the viewer in rapid succession for a period of time (47). After this period of time a different set of the obfuscated images can be presented to the recipient for a period of time (48). This process can continue until the designated viewing time (e.g., preselected by the sender, or a fixed time period) had elapsed, and/or it is detected that the recipient attempted to capture copies of one or more images (49). Typically, a period of time is required for most devices to perform a screen capture of an image, such that a recipient can normally be prevented from capturing multiple screen shots in rapid succession. However, if the viewing time for an image is longer than the time required to capture the same number of screen shots as images in an obfuscated set, it may, in some cases, be possible for a recipient to acquire sufficient data to reconstruct the original image (e.g., all imagines in a set of obfuscated images). By using multiple sets of obfuscated images that are displayed for a period of time shorter than the viewing time, and on the same time scale typically required to capture a single screen shot, the recipient can be prevented from capturing multiple obfuscated images from a single obfuscated set. This process can greatly increase the difficulty of reconstructing the original image if multiple obfuscated images are captured.

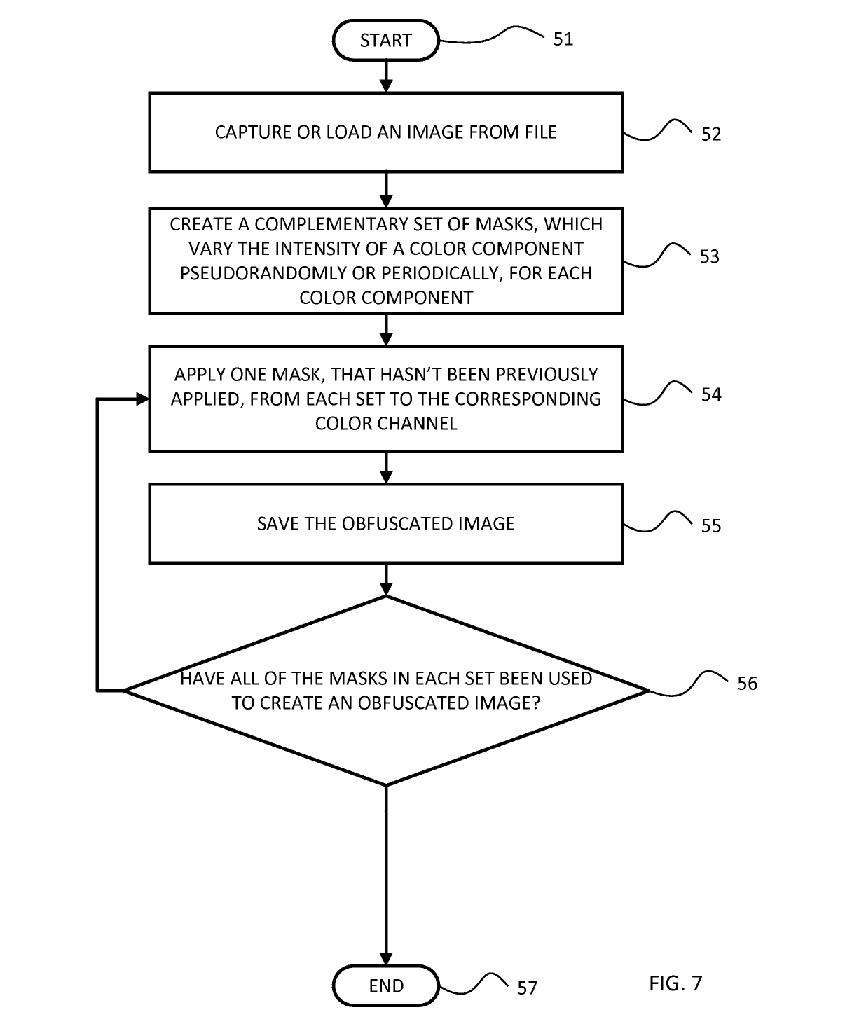

FIG. 7 depicts a flowchart showing an embodiment for a method of using sets of continuous masks to obfuscate an image. The process depicted in FIG. 3 and described above can be used to create what can be referred to as a discrete mask, or a mask with discrete character. This means that as boundaries between areas in the mask are crossed, the factor which modifies each of the color components (or other characteristic) may drop from 1 to 0 or rise from 0 to 1. In this exemplary situation, an indication of 1 means that in the resulting obfuscated image, the color component is shown in that area at the intensity that it exists in the original image and 0 means that the color component is omitted from that area. This is a discontinuous change in the influence of the mask on the display of the color component, e.g., a color channel in any given area is either “on” or “off.” A continuous mask technique can vary the factor that modifies the display of the color component (or other characteristic) in any given area to many different values between zero and one. This type of mask can be referred to as having continuous character. Use of a mask with continuous character can increase the difficulty in identifying the mask used to obfuscate an image, which in turn increases the difficulty in reconstructing the original image from a subset of images captured from a set of obfuscated images. At the start of the process for obfuscating an image using continuous masks (51), an image is captured or loaded from a file (52). A set of unique complementary masks is created for each of the color components that will be used in the obfuscation (53). In the complementary masks, each mask would vary not only the presence or absence of a particular color component, but also the intensity of a color component, pseudorandmoly or periodically, for each color component. For example, where a RGB color model is used, there are three color components, and three sets of complementary masks can be used to obfuscate the image. If each set consists of two masks, then a total of six masks would be used in the obfuscation. Once all of the masks are created, one mask from each set can be applied to the original image (54), resulting in an obfuscated image that can be saved (55). A different mask from each set can then be applied to the original image to create another obfuscated image. This process is repeated until all masks in the complementary set of masks for each color component have been used to generate an obfuscated image (56), at which point the process ends (57). For example, where a RGB color model is used, and a total of six complementary masks are used to create at least two complementary images, additional sets of complementary obfuscated images can be created by applying different combinations of the masks to the original image.

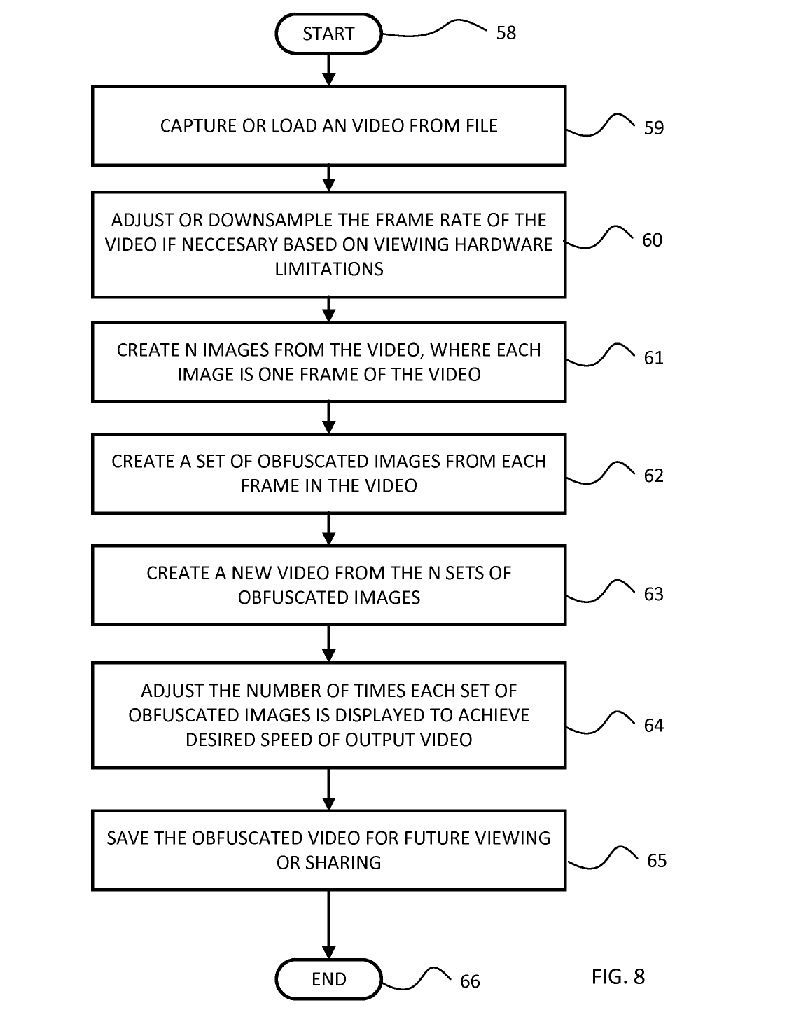

FIG. 8 depicts a flowchart showing an embodiment of a method for obfuscating a video. Generally, the process of obfuscating a single image, described above, can be used to obfuscate a video by treating each frame of the video as a static image, obfuscating each image, and then playing the obfuscated image sets back at the appropriate rate and in the appropriate sequence to create a reasonable reproduction of the original video. Specifically, at the start of the process (58), a video can be captured or loaded from a file (59). The video may be required to be down sampled and/or otherwise modified or converted, so that the obfuscated video is compatible with the display hardware on which it will be viewed. For example, if a video possesses a native frame rate of sixty frames per second, and at least two obfuscated images are created for each frame to obfuscate the video, the obfuscated video would need to be played at one-hundred twenty frames per second to maintain the same video speed. Because many devices are unable to display videos at rates faster than sixty frames per second. the original video may be adjusted or downsampled based on hardware limitations (60) (e.g., to thirty frames per second or another rate less than that of the maximum capabilities of one or more receiving devices). The video can then be divided into N images, were each image is one frame of the video (61), and N is an integer. One or more sets of obfuscated images are then created from each frame in the video (62), e.g., using one or more of the processes described above. A new video (e.g., an obfuscated video) can then be created from the sets of obfuscated images (63) by creating a frame from each set of obfuscated images and ordering the frames to reproduce the original video (63). If necessary, the number of times each set of obfuscated images is displayed can be adjusted to achieve the desired speed of output of the video (64). The video can be saved for future viewing or dissemination (65), thus completing the process (66).

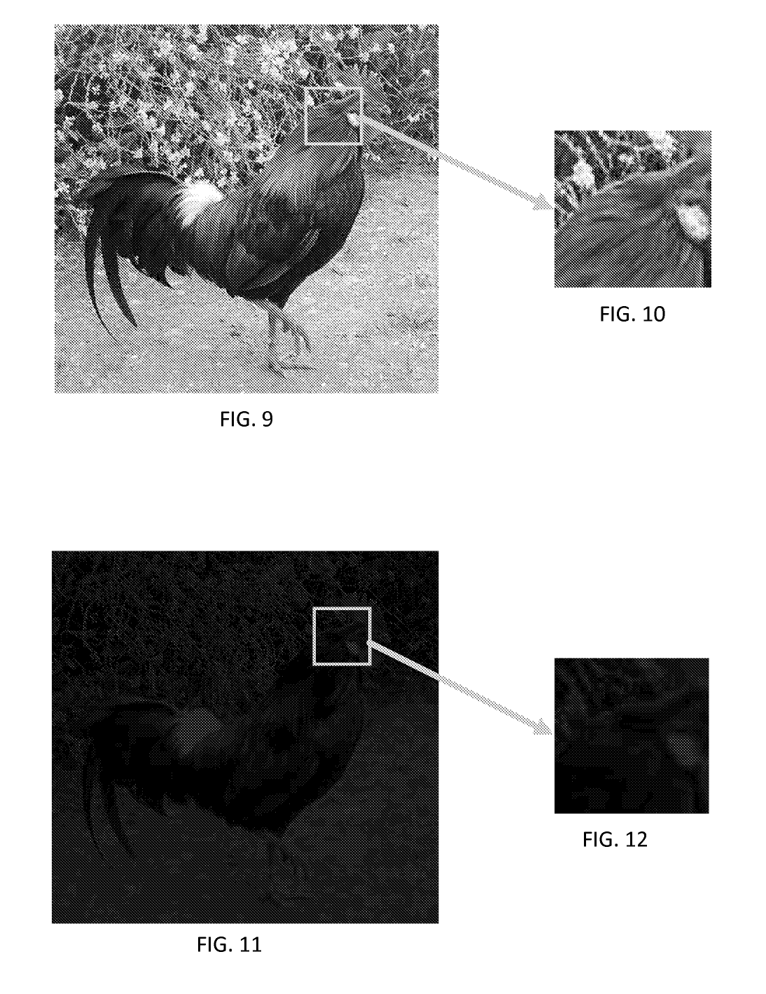

FIG. 9 depicts a color image of a rooster, an exemplary starting/original image, which is shown in subsequent figures, obfuscated using various techniques. FIG. 10 depicts a magnified view of a portion of the image of FIG. 9 to depict greater detail (e.g., pixels and/or other detailed features).

FIGS. 11 through 16 illustrate the concept of decomposing an image into different color components. FIGS. 11, 13, and 15 depict the blue, red, and green color components, respectively, of the original image shown in FIG. 9. FIG. 12, FIG. 14, and FIG. 16 depict magnified views of a portion of the images of FIGS. 11, 13, and 15, respectively, the portion shown corresponding to that depicted in FIG. 10. It should be noted that while FIGS. 11 through 16 depict blue, red, and green color components of an original image, this is one exemplary choice of color components and/or other characteristics that could be used to obfuscate an image. Use of red, green, blue color components is common when digitally storing an image, and as such, many of the processes described herein may refer to use of a RGB color model; however, any characteristic(s) of an image can be used to facilitate obfuscation thereof without departing from the present disclosure. It should be noted that simply presenting a single color component of an original image does not, itself, obfuscate the image. For example, the single-color images shown in FIGS. 11 through 16 could be converted to grayscale, and would show a clear, though chromatically inaccurate, representation of the original image.

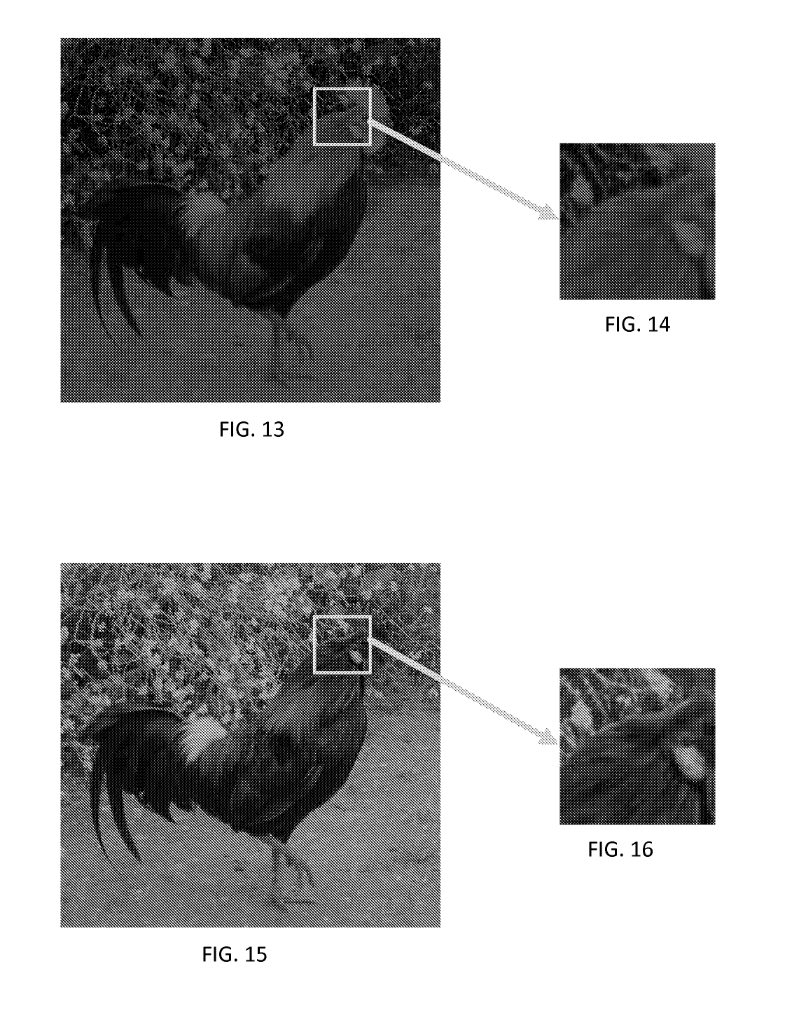

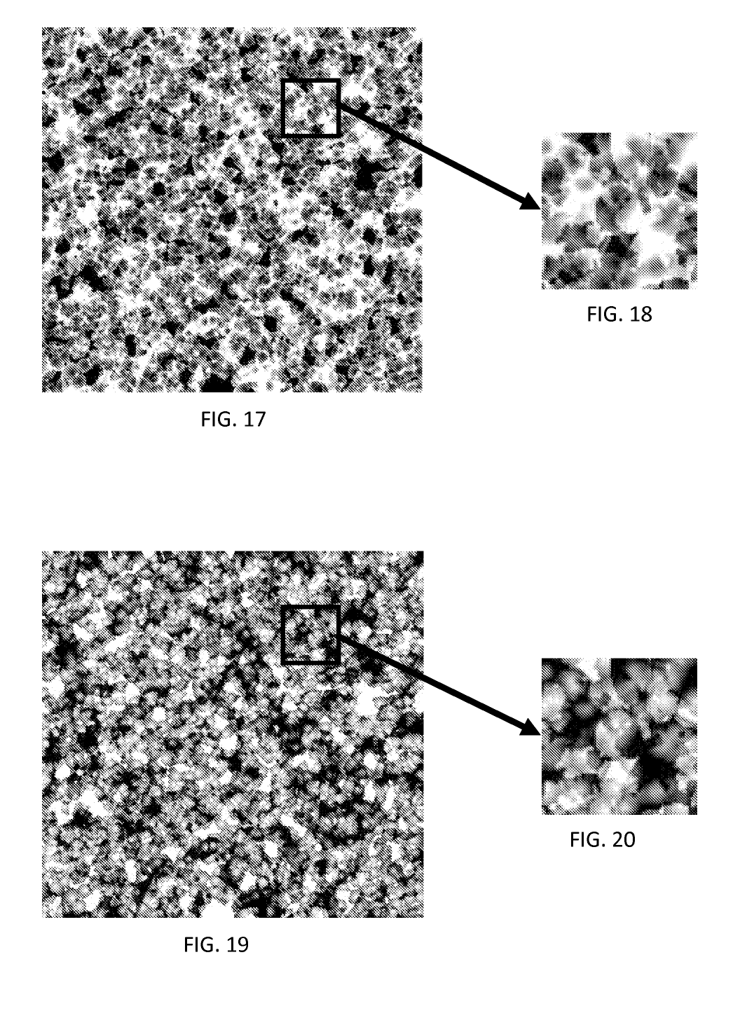

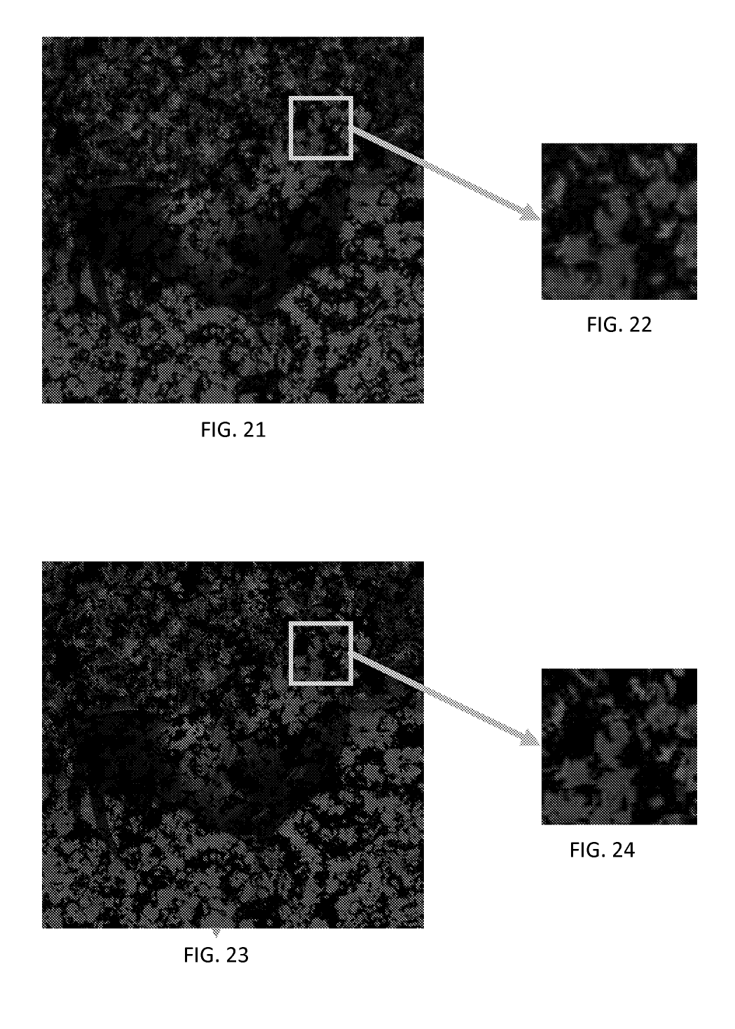

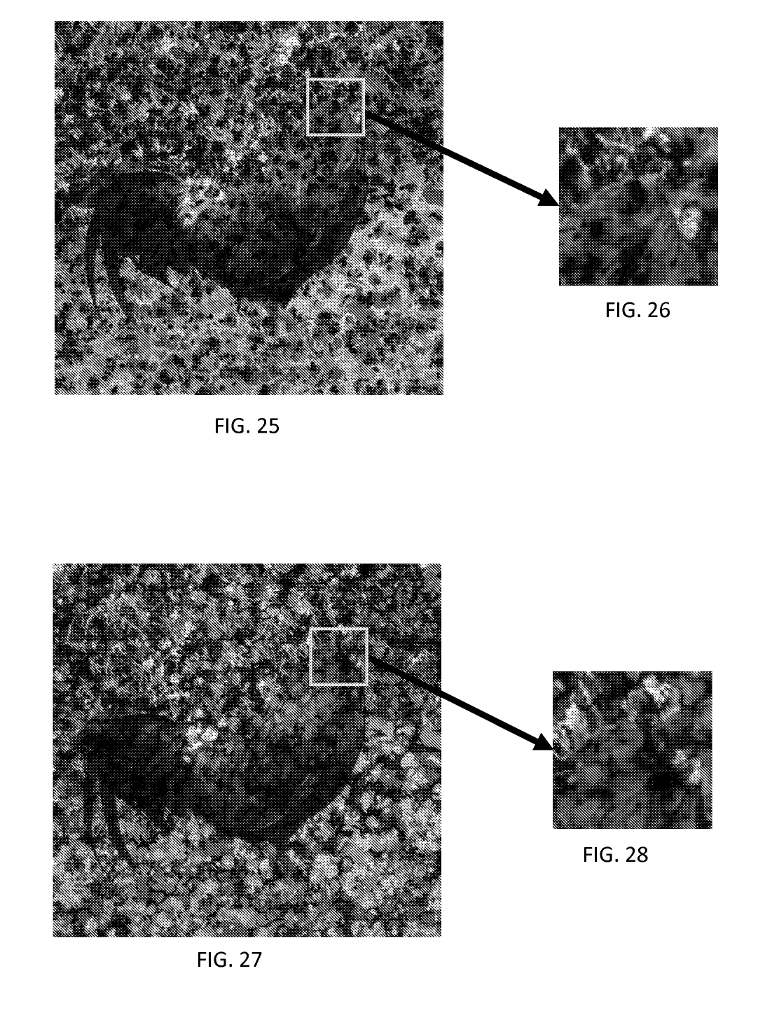

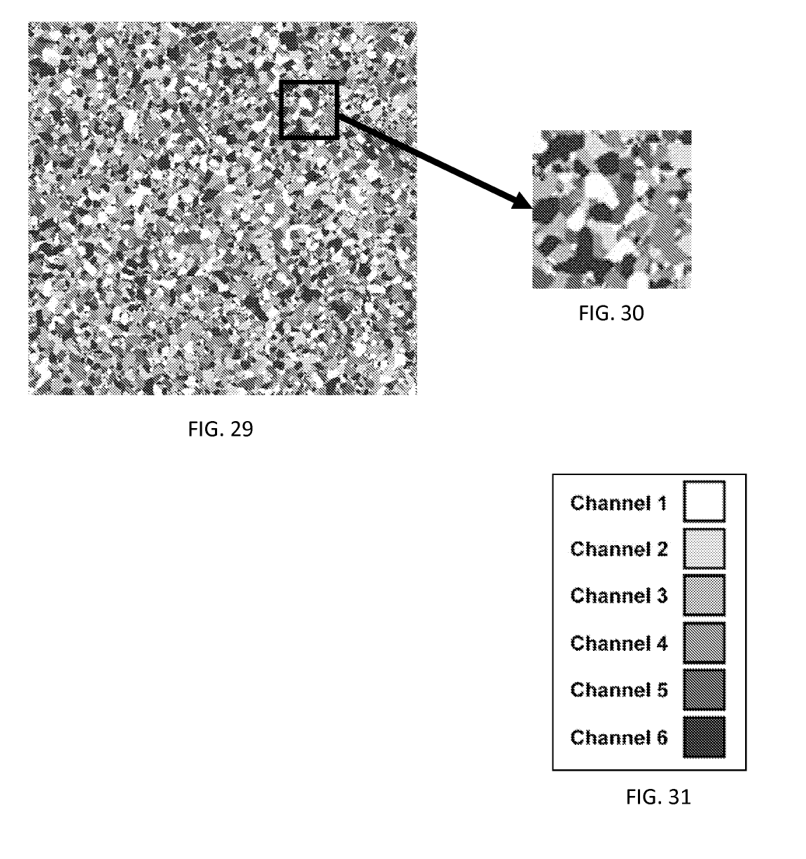

FIG. 17 and FIG. 19 depict exemplary embodiments of two paired continuous masks that can be applied to a color channel to obfuscate an image. FIG. 18 and FIG. 20 depict magnified views of a portion of the masks of FIGS. 17 and 19, respectively, to enable visualization of details thereof. The masks shown in FIGS. 17 through 20 can be considered to be continuous masks due to the presence of gradual transitions between differing intensity levels used in the mask. In contrast, the mask shown in FIGS. 29 and 30 includes abrupt transitions between intensity for a given color component (e.g., each color channel is either present or absent at a given location). The masks shown in FIG. 17 and FIG. 19 are complementary to one another, because if the two masks are applied to a color component together, they would produce the original color component. For example, intensity of the masks at any given point was assigned a numeric value ranging from zero (e.g., black) to one (e.g., white), the summation of the two masks would be an array of ones. As such, using the RGB color components, a set of three different pairs of complementary masks could be used to obfuscate an image by creating two complementary obfuscated images. The first image could be created by applying one mask from each of the three pairs (one pair per color channel) to the original image. The second, complementary image, could be created by applying the second mask from each of the three pairs of masks to the original image. Thus, through the use of six different masks, two complementary images could be created. The two complementary images, when viewed independently, would appear to be a heavily obfuscated image, as shown, for example, in FIGS. 25 through 28. FIG. 25 shows a first obfuscated image (e.g., created by applying the mask of FIG. 17 to each of the color components (shown in FIGS. 11 through 16) for the original image shown in FIG. 9), while FIG. 27 shows a second obfuscated image (e.g., created by applying the mask of FIG. 19 to each of the color components (shown in FIGS. 11 through 16) for the original image shown in FIG. 9). FIGS. 26 and 28 depict magnified views of portions of the images shown in FIGS. 25 and 27, respectively, to enable visualization of details thereof. In addition to creating an image that is obfuscated, in various embodiments, obfuscated images can be created in a manner that cannot be easily decomposed or processed to enable visualization of the original image, even in a grayscale representation. Because a different mask is can be applied to each of the color components of an image, analyzing a color component independently will not reveal the original image. For example, FIG. 21 depicts a color image showing the red color channel of FIG. 13, having the mask of FIG. 19 applied thereto to form a partial obfuscated image (which could be combined with the results of applying the mask of FIG. 19 to the other color channels of the original image to obtain one member of a set of obfuscated images). FIG. 22 depicts a magnified view of a portion of the image of FIG. 19. FIG. 23 depicts the image of FIG. 22 in grayscale, while FIG. 24 depicts a magnified view of a portion thereof. As demonstrated by FIGS. 21 through 24, even when the red color channel of FIG. 21 is converted to a grayscale image, as shown in FIG. 23, the original image remains unobvious.

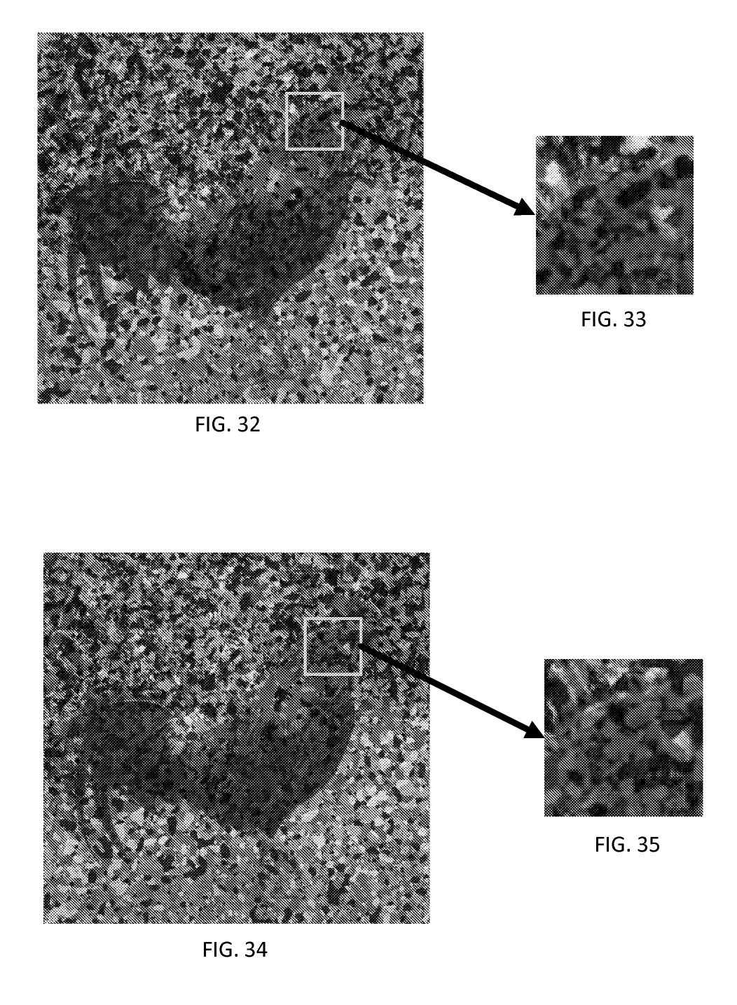

As described above, FIG. 29 depicts an example of a discrete mask having six different color channels. FIG. 30 depicts a magnified view of a portion of the image shown in FIG. 29, while FIG. 31 depicts a legend indicating which areas in the image of FIG. 29 correspond to the six different color channels shown. In comparison to the mask shown in FIG. 17, the mask of FIG. 29 includes abrupt transitions in intensity of each color component, while the mask of FIG. 17 includes gradual transitions in intensity. Each area shown in the mask of FIG. 29 includes a different color channel Each channel can include one or more color components. In the depicted example, the six color channels can include red, green, and blue color components, as well as combinations thereof, such as red-green, red-blue, and green-blue. In the depicted example, the complement of red would be green-blue, the complement of green would be red-blue, and the complement of blue would be red-green. These complementary relationships can be used to create a set of two complementary images, in which the first image is created by assigning color components to all of the areas represented by the color channels (e.g., through application of a mask). The second image can be created by assigning the complements of the color components that were assigned to each area in the first image to a second image. This process can create a set of complementary images, as depicted in FIGS. 32 and 34, each of the depicted imagines including complementary color components in corresponding areas. FIGS. 33 and 35 depict magnified views of a portion of the images shown in FIGS. 32 and 34, respectively. While FIGS. 29 through 31 depict an embodiment in which six color channels are used, it should be understood that in various embodiments fewer or more color channels could be present. For example, an embodiment utilizing solely red, green, and blue channels would have three color channels; an embodiment utilizing cyan, magenta, yellow, and black would have four color channels; and an embodiment utilizing red, green, blue, red-green, red-blue, green-blue, red-green-blue, and black would have eight color channels.

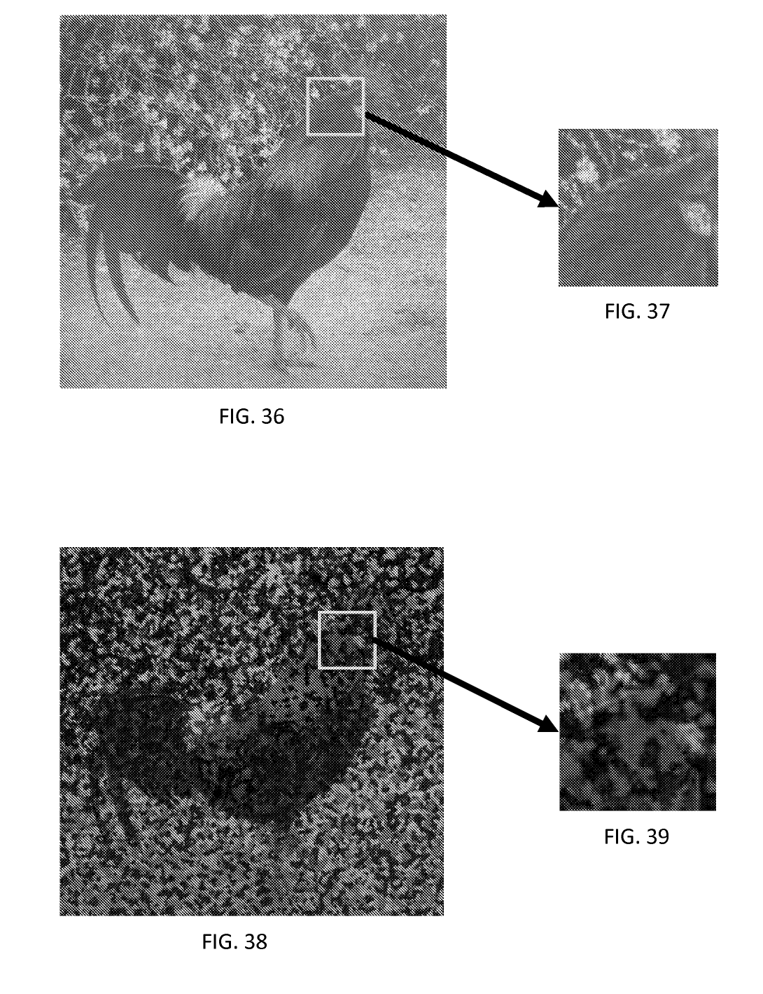

FIG. 36 depicts an embodiment of an image that can be perceived (e.g., by a human eye) when displaying a complementary set of obfuscated images in rapid succession. FIG. 37 depicts a magnified view of the portion of the image shown in FIG. 36. The image of FIG. 37 was captured by photographing the display of a set of obfuscated images using a digital camera having a long shutter time and is one representative example of an image observable when rapidly displaying one or more of the described variations of obfuscated images.

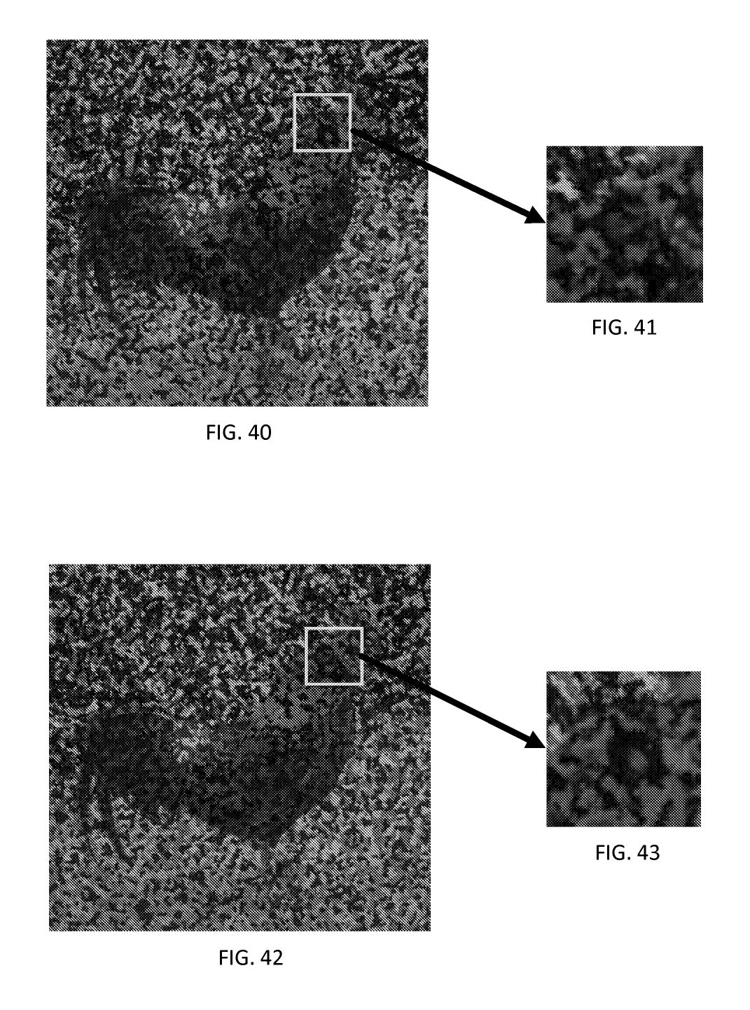

FIGS. 38 through 43 depict images showing embodiments of obfuscated images that can be obtained by applying a three-component discrete mask to the original image shown in FIG. 9. Specifically, FIGS. 38, 40, and 42 are complementary images, obtained by applying a set of masks using the red, green, and blue color components of the images, while FIGS. 39, 41, and 43 depict magnified views of corresponding portions of FIGS. 38, 40, and 42, respectively. It should be understood that while FIGS. 38 through 43 depict an example by which three complementary obfuscated images are produced, while previous embodiments relate to examples by which two complementary obfuscated images are produced, any number of complementary images could be produced, such that the conceptual sum of all of the images would result in the individual image, and successive display of the obfuscated images can result in a representation of the original image that is visually perceptible to a user. The advantage of using a larger number of obfuscated, complementary images is that the amount of information presented in any single image is less than embodiments in which a smaller set of obfuscated images is used. However, due to the display limitations of a receiving device (e.g., screen refresh rate), use of a larger number of images may require a longer period of time to display, causing the image displayed to a user to appear to flicker, blur, and/or flash depending on the limitations of the display device.

Embodiments usable within the scope of the present disclosure thus relate to systems and methods usable to obfuscate an original image by forming a set of two or more complementary, obfuscated images from the original image that, when displayed in rapid succession, generate a representation of the original image that is able to be visualized by a recipient, while at any given instant in time, only a single obfuscated image is physically displayed and able to be captured. One method of obfuscation can include separating an original image into its color components (e.g., red, green, and blue color channels), though other characteristics in addition to or in lieu of color could also be usable to obfuscate images. A set of complementary masks (e.g., a pseudorandom collection of pixels and/or areas that will be displayed or concealed, optionally at varying intensities) for each color channel can be used to form the complementary obfuscated images.

While various embodiments usable within the scope of the present disclosure have been described with emphasis, it should be understood that within the scope of the appended claims, the present invention can be practiced other than as specifically described herein.

What is claimed is:

1. A method for preventing screen capture of an image, the method comprising:
creating a plurality of obfuscated partial images from an original image; and
displaying the plurality of obfuscated partial images on a display device in succession, wherein successive display of the plurality of obfuscated partial images creates a representation of the original image perceivable by a user.

2. The method of claim 1, wherein the step of creating the plurality of obfuscated images from the original image comprises:
applying a first mask to the original image, wherein the first mask comprises at least a first region and a second region to form a first obfuscated image, wherein portions of the first obfuscated image corresponding to said at least a first region are displayed, and wherein portions of the first obfuscated image corresponding to said at least a second region are concealed; and
applying a second mask to the original image, wherein the second mask comprises said at least a first region and second region to form a second obfuscated image complementary to the first obfuscated image, wherein portions of the second obfuscated image corresponding to said at least a first region are concealed, and wherein portions of the second obfuscated image corresponding to said at least a second region are displayed.

3. The method of claim 1, wherein the step of creating the plurality of obfuscated images comprises:
separating the original image into a plurality of starting images based on a characteristic of the original image, wherein each of said starting images comprises a value for said characteristic different from each other of said starting images; and
applying a set of complementary masks to each of said starting images to form a plurality of obfuscated images, wherein each mask comprises at least a discrete first region and a discrete second region, and wherein portions of the plurality of staring images corresponding to said discrete first region are displayed and portions of the plurality of starting images corresponding to said discrete second region are concealed.

4. The method of claim 3, wherein the step of separating the original image into the plurality of starting images based on the characteristic comprises separating the original image based on a plurality of color components present in the original image.

5. The method of claim 4, wherein the step of applying the set of complementary masks to each of said starting images comprises assigning said at least a discrete first region and discrete second region a value of zero or one, and wherein portions of the plurality of starting images corresponding to a discrete region having a value of zero are not displayed and portions of the plurality of starting images corresponding to a discrete region having a value of one are displayed.

6. The method of claim 4, wherein the step of applying the set of complementary masks to each of said starting images comprises assigning said at least a discrete first region and discrete second region a value ranging from zero to one, and wherein an intensity of a color component of portions of the plurality of starting images in a resulting obfuscated image corresponds to the value of a corresponding region of one of the masks.

7. The method of claim 1, further comprising the steps of:
detecting a screen capture associated with the display device, connection of the display device to an additional device, or combinations thereof; and
ceasing display of the plurality of obfuscated images, deleting the plurality of obfuscated images, or combinations thereof, responsive to detection of the screen capture, the connection, or combinations thereof.

8. The method of claim 1, wherein the original image comprises a frame of a video, the method further comprising:
separating the video into a plurality of frames;
creating a plurality of obfuscated images corresponding to each frame of the plurality of frames; and
displaying each of the pluralities of obfuscated images in succession to create a representation of the video.

9. The method of claim 1, wherein the step of creating the plurality of obfuscated images comprises creating at least a first set of obfuscated images and a second set of obfuscated images, wherein the first set and the second set are non-complementary.

10. A system for obfuscating an image, the system comprising:
a sending device comprising a display;
a non-transitory data storage medium associated with a processor and in communication with the sending device;
a receiving device comprising a display;
computer instructions on the non-transitory data storage medium for instructing the processor to capture an original image, load an original image, generate an original image, receive an original image from the sending device, or combinations thereof;
computer instructions on the non-transitory data storage medium for instructing the processor to create a plurality of obfuscated images from the original image;
computer instructions on the non-transitory data storage medium for instructing the processor to transmit and display the plurality of obfuscated images on the display of the receiving device successively to create a representation of the original image perceivable by a user.

11. The system of claim 10, further comprising computer instructions on the non-transitory data storage medium for instructing the processor to display the representation on the display of the sending device and receive a confirmation from the sending device to transmit the representation to the receiving device.

12. The system of claim 10, further comprising computer instructions on the non-transitory data storage medium for instructing the processor to receive a time period from the sending device and to cease display of the plurality of obfuscated images on the display of the receiving device after expiration of the time period.

13. The system of claim 10, wherein the computer instructions for instructing the processor to create the plurality of obfuscated images further instruct the processor to apply a set of complementary masks to said original image to form a plurality of obfuscated images, wherein each mask comprises at least a discrete first region and a discrete second region, and wherein portions of the original image corresponding to said discrete first region are displayed in a resulting obfuscated image and portions of the plurality of starting images corresponding to said discrete second region are concealed from the resulting obfuscated image.

14. The system of claim 13, wherein the computer instructions for instructing the processor to create the plurality of obfuscated images further instruct the processor to separate the original image into a plurality of starting images based on a characteristic of the original image, wherein each of said starting images comprises a value for said characteristic different from each other of said starting images, and wherein the computer instructions instruct the processor to apply the set of complementary masks to each of said plurality of starting images.

15. The system of claim 13, wherein the set of complementary masks comprises a pre-generated set of complementary masks stored in the non-transitory data storage medium.

16. The system of claim 10, further comprising computer instructions on the non-transitory data storage medium for instructing the processor to detect a screen capture associated with the receiving device, connection of the receiving device to an additional device, or combinations thereof, and cease display of the plurality of obfuscated images, delete the plurality of obfuscated images, or combinations thereof, responsive to detection of the screen capture, the connection, or combinations thereof.

17. The system of claim 10, wherein the non-transitory data storage medium, the processor, or combinations thereof are integrally associated with the sending device.

18. The system of claim 10, wherein the non-transitory data storage medium, the processor, or combinations thereof are disposed within a device external to the sending device and the receiving device.

19. Computer instructions on a non-transitory data storage medium which when executed by a processor cause the processor to perform the steps of:
creating a plurality of obfuscated images from an original image; and
displaying the plurality of obfuscated images on a display device in succession, wherein successive display of the plurality of obfuscated images creates a representation of the original image perceivable by a user.

20. The computer instructions of claim 19, wherein the computer instructions for instructing the processor to create the plurality of obfuscated images from the original image cause the processor to apply a set of complementary masks to the original image to form the plurality of obfuscated images, wherein each mask comprises at least a discrete first region and a discrete second region, and wherein portions of the original image corresponding to said discrete first region are displayed and portions of the plurality of starting images corresponding to said discrete second region are concealed.

21. The computer instructions of claim 20, wherein the computer instructions for instructing the processor to create the plurality of obfuscated images further instruct the processor to separate the original image into a plurality of starting images based on a characteristic of the original image, wherein each of said starting images comprises a value for said characteristic different from each other of said starting images, and wherein the computer instructions instruct the processor to apply the set of complementary masks to each of said plurality of starting images.

22. The computer instructions of claim 19, wherein the computer instructions further cause the processor to detect a screen capture associated with the receiving device, connection of the receiving device to an additional device, or combinations thereof, and cease display of the plurality of obfuscated images, delete the plurality of obfuscated images, or combinations thereof, responsive to detection of the screen capture, the connection, or combinations thereof.
